(19) United States
(12) Patent Application Publication
(10) Pub. No.: US 2004/0203802 A1
(43) Pub. Date: Oct. 14, 2004

(54) Process for optimizing speech coding as a function of end user device characteristics

(76) Inventors: Mark Alan McCormick, Naperville, IL (US); Thomas Lee McRoberts, Naperville, IL (US)

Correspondence Address: PATTON BOGGS, 1660 LINCOLN ST, SUITE 2050, DENVER, CO, 80264, US

(21) Appl. No.: 10/329,183

(22) Filed: Dec. 23, 2002

(51) Int. Cl. H04Q 7/20

(52) U.S. Cl. 455/445; 455/422.1; 455/575.1

(57) ABSTRACT

In response to a mobile subscriber station to mobile subscriber station call, the intelligent coding process transmits data during the call setup process from the originating mobile switching center to the mobile switching center that serves the called party, indicative of the characteristics of the originating end user device and the coding processes in use at the originating end user device. The intelligent coding process also signals the inter-mobile switching center network to indicate that this call connection does not require the use of a vocoder in the network transmission of the call. The inter-mobile switching center trunks then pass the coded data received from the codec in the originating mobile subscriber station to the mobile switching center that serves the called party, where the coded data is transmitted to the mobile subscriber station of the called party. The codec in this mobile subscriber station performs the speech decoding necessary to transmit the data to the called party.

### FIELD OF THE INVENTION

This invention relates to wireless telephone communications networks and, in particular, to a speech coding system for efficient bandwidth usage in transmissions between end user devices.

### PROBLEM

It is a problem in the field of telephone communications networks to maximize the utilization of the available transmission bandwidth. For wireless applications, bandwidth is a scarce resource and the use of speech compression is critical. In addition, it is very important to integrate the speech compression process with the error protection and error concealment processes operational in the wireless telephone communications network. However, given the number of speech coding standards and the need to interact with legacy systems and disparate end user devices, a significant problem encountered in present telephone communications networks is the inefficiency that results from coding the input speech using a standard that is incompatible with that used by the receiving end user device and the additional coding that takes place in the wireless telephone communications network. The encoding and decoding processes are executed by coding the received speech at the originating end user device via a codec, then transmitting the coded speech signal to be again processed in the network by a vocoder using another coding standard, such as the network standard G.711, without regard for the needs of the called party's end user device. The called party's end user device then must translate the received vocoder output via a codec into speech signals for the called party. Therefore, unnecessary speech coding resources are used to serve this communication connection and the available transmission bandwidth is not used efficiently.

An ITU standard for speech coders that provides toll quality audio at 64 Kbps using either A-Law or μ-Law PCM process is defined in the G.711 standard. The G.711 format has been the standard for digitizing voice by telephone communications networks starting in the 1960s. Typically, the received speech signals are encoded by the telephone communication network using a vocoder executing the G.711 standard since that is the standard implemented in the network components. However, the G.711 standard implements a relatively inefficient speech coding process. In addition, in wireless applications, the mobile subscriber stations encode the speech using a codec prior to the transmission to the telephone communications network, using a protocol such as EVRC for mobile subscriber stations, and the sequential encoding by the network results in additional delays and unnecessary coding steps. Further, the lossy nature of the various coding algorithms used to convey the input speech signal to the called party's user device and produce the output speech signals are not considered. The sequential application of lossy coding algorithms may result in output speech or other type of data that is of unacceptable quality for use by the called party's end user device.

### SOLUTION

The above-described problems are solved and a technical advance achieved by the present system for optimizing speech coding as a function of end user device characteristics, termed “intelligent coding process” herein. The intelligent coding process obtains data indicative of the end user device characteristics during the call setup process and can determine the optimal speech coding process necessary to efficiently use the available bandwidth and match the speech coding requirements of the end user devices.

In response to a mobile subscriber station to mobile subscriber station call, the intelligent coding process transmits data during the call setup process from the originating mobile switching center to the mobile switching center that serves the called party, indicative of the characteristics of the originating mobile subscriber station and the coding processes in use at the originating mobile subscriber station. The intelligent coding process also signals the inter-mobile switching center network (ISUP, 3GPP, or 3GPP2) to indicate that this call connection does not require the use of a vocoder in the network transmission of the call. The inter-mobile switching center trunks then pass the coded data received from the codec in the originating mobile subscriber station to the mobile switching center that serves the called party, where the coded data is transmitted to the mobile subscriber station of the called party. The codec in this mobile subscriber station performs the speech decoding necessary to transmit the data to the called party. If the codecs used in the originating mobile subscriber station does not match the codec used in the called party's mobile subscriber station, an intermediate coding step can be implemented in either the originating mobile switching center or the receiving mobile switching center, typically eliminating the need for the use of the standard G.711 network coding to effect the transmission.

### BRIEF DESCRIPTION OF THE DRAWINGS

FIG. 1 illustrates in block diagram form the intelligent coding process and a typical telephone communications network in which it is operational; and

FIG. 2 illustrates in flow diagram form the operation of the intelligent coding process in interconnecting two end user devices.

### DETAILED DESCRIPTION

Speech coding refers to the process of reducing the bit rate of digital speech representation for transmission or storage, while maintaining a speech quality that is acceptable for the application. Speech coding is a technique sometimes referred to as lossy coding. The input and output signals are not mathematically equivalent but they are perceptually similar. Differences can be heard, but are hopefully not annoying or are acceptable for the application. Traditionally speech coding is used for communication applications using telephony bandwidth speech (200 Hz-3.5 kHz). However, changes in the communication infrastructure have opened the door for algorithms targeting all types of bandwidths from 3.5 kHz all the way up to CD quality sound. Speech coding can include simultaneous voice and video or other data. The number and variety of applications has resulted in many implementations of speech coders.

Designing speech coders is a balancing game between quality, bit rate, delay and complexity. The quality is a function of the bit rate, but the lowest reasonable bit rate must be selected since the speech coder is sharing a communications channel with other data transmissions. For telephone quality speech, the standard bit rate is 8 bits μ-law coding per sample. Using an 8 kHz sampling rate results in 64 kb/s of data generated for the received speech. Speech coding algorithms can maintain an acceptable quality audio output at substantially lower bit rates all the way down to 16 kb/s. At lower bit rates there is some loss in audio output quality, but even at bit rates as low as 1200 bits/s the speech that is output is still quite intelligible.

The delay of a speech coding process usually consists of three major components. Most low bit rate speech coders process one frame of speech data at a time. The speech parameters are updated and transmitted for every frame. In addition, in order to analyze the data properly, it is sometimes necessary to analyze data beyond the frame boundary, also termed “look-ahead.” Therefore, before the speech can be analyzed, it is necessary to buffer a frame of speech data plus any look-ahead data. The delay caused by this buffering is termed algorithmic delay, and is present for every type of speech coding algorithm. The second major delay contribution results from the time it takes the speech encoder to analyze the speech and for the decoder to reconstruct the speech, which delay is termed processing delay. This delay is a function of the hardware used to implement the speech coder. The third component of delay is termed the communication delay, which is the time it takes for an entire frame of data to be transmitted from the speech encoder to the speech decoder. The sum of all three of these delay components is termed one-way system delay.

An ITU standard for speech coders that provides toll quality audio at 64 Kbps using either A-Law or μ-Law PCM process is defined in the G.711 standard. The G.711 format has been the standard for digitizing voice by the telephone companies starting in the 1960s. However, newer algorithms have lowered the bit rate considerably, and respectable quality can be obtained at 16 Kbps and well below that, depending on the quality of all the components in the system. Some of the presently available coding standards are: G.726 Adaptive Pulse Code Modulation, G.728 Low-Delay Code-Excited Linear Predictive (CELP), and G.729 CS-Adaptive Code-Excited Linear Predictive (ACELP). In addition, in the wireless standards, the Code-Excited Linear Predictive Coding paradigm has become the basis for nearly all cellular standards currently in use. Moreover, an innovative variation on Code-Excited Linear Predictive Coding referred to as RCELP has become the basis for the second generation CDMA systems in the US. However, the received speech signals are typically encoded by the telephone communication network using the G.711 standard since that is the standard implemented in many legacy network components. The G.711 standard implements a relatively inefficient speech coding process. In addition, many end user devices encode the speech prior to the transmission to the telephone communications network and the sequential encoding results in additional delays and unnecessary coding steps to ensure sufficient quality for the end user devices.

G.711 is the international standard for encoding telephone audio on a 64 kbps channel. It is a pulse code modulation (PCM) scheme operating at an 8 kHz sample rate, with 8 bits per sample. According to the Nyquist theorem, which states that a signal must be sampled at twice its highest frequency component, G.711 can encode frequencies between 0 and 4 kHz. There are two different variations of the G.711 encoding in use: A-law and μ-law, where A-law is the standard for international circuits. Each of these encoding schemes is designed in a roughly logarithmic fashion. Lower signal values are encoded using more bits; higher signal values require fewer bits. This ensures that low amplitude signals will be well represented, while maintaining enough range to encode high amplitudes.

Cellular Communication Network Philosophy

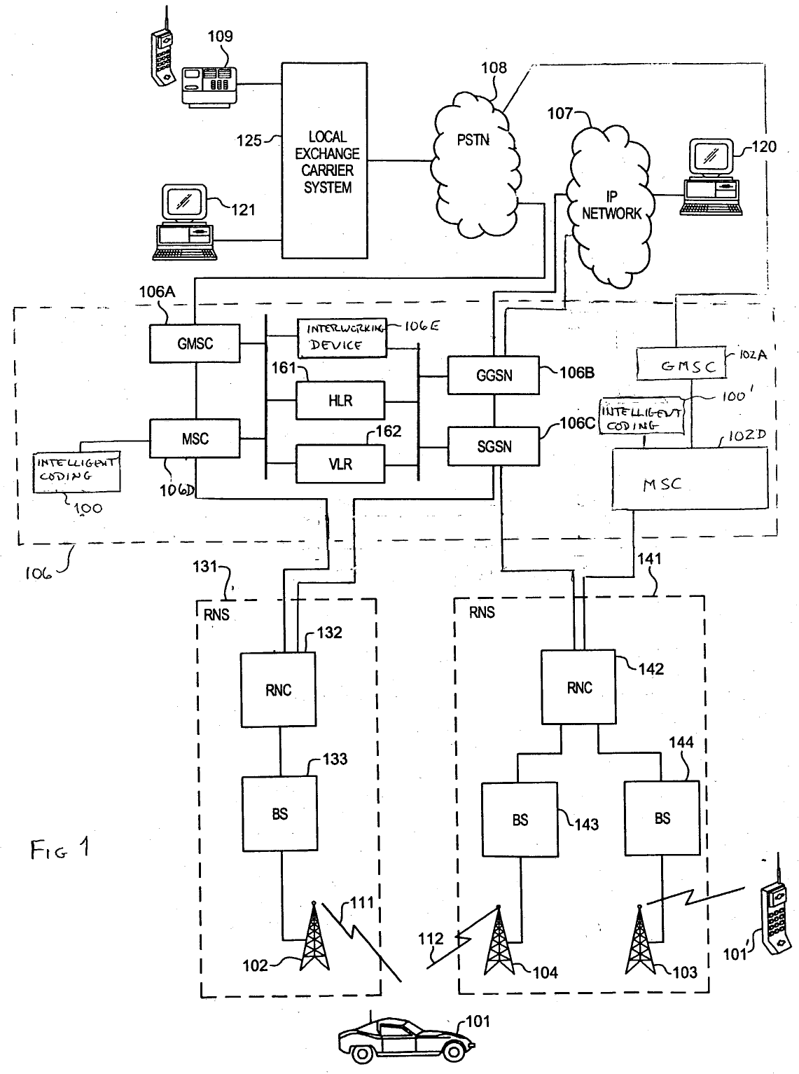

Cellular communication networks 106 as shown in block diagram form in FIG. 1 provide the service of connecting wireless telecommunication customers, each having a wireless subscriber device, to both land-based customers who are served by the common Carrier Public Switched Telephone Network (PSTN) 108, servers 120 connected to IP Network 107, as well as other wireless telecommunication customers. In such a network (shown with a focus on 3GPP as an example), all incoming and outgoing calls are routed through Mobile Switching Centers (MSC) 102D, 106D, each of which is connected to a Radio Network Subsystem (RNS) 131, 141 which communicate with wireless subscriber devices 101, 101′ located in the area covered by the cell sites. The wireless subscriber devices 101, 101′ are served by the Radio Network Subsystems (RNS) 131, 141, each of which is located in one cell area of a larger service region. Each cell site in the service region is connected by a group of communication links to the Mobile Switching Centers 102D, 106D. Each cell site contains a group of radio transmitters and receivers, termed a “Base Station” herein, with each transmitter-receiver pair being connected to one communication link. Each transmitter-receiver pair operates on a pair of radio frequencies to create a communication channel: one frequency to transmit radio signals to the wireless subscriber device and the other frequency to receive radio signals from the wireless subscriber device. The Mobile Switching Centers 102D, 106D, in conjunction with the Home Location Register (HLR) 161 and the Visitor Location Register (VLR) 162, manage subscriber registration, subscriber authentication, and the provision of wireless services such as voice mail, call forwarding, roaming validation and so on. The Mobile Switching Centers 102D, 106D are connected to a Gateway Mobile Services Switching Center (GMSC) 106A as well as to the Radio Network Controllers 132, 142, with the Gateway Mobile Services Switching Center 106A serving to interconnect the Mobile Switching Center 106D with the PSTN/IP Network 108. In addition, the Radio Network Controllers 132, 142 are connected via Serving GPRS Support Node 106C and thence the Gateway GPRS Support Node (GGSN) 106B (or Packet Data Support Node—PDSN for 3GPP2 networks) to the IP Network 107. The Radio Network Controllers 132, 142 at each cell site Radio Network Subsystem 131, 141 control the transmitter-receiver pairs at the Radio Network Subsystem 131, 141, respectively. The control processes at each Radio Network Subsystem 131, 141 also control the tuning of the wireless subscriber devices to the selected radio frequencies.

The wireless subscriber device 101, for example, is simultaneously communicating with two Base Stations 133 & 143, which constitutes a soft handoff of the call between the Base Stations. However, a soft handoff is not limited to a maximum of two Base Stations. When in a soft handoff, the Base Stations serving a given call must act in concert so that commands issued over RF channels 111 and 112 are consistent with each other. In order to accomplish this consistency, one of the serving Base Stations may operate as the primary Base Station with respect to the other serving Base Stations. Of course, a wireless subscriber device 101 may communicate with only a single Base Station if this is determined to be sufficient by the cellular communication network.

The control channels that are available in this system are used to setup the communication connections between the subscriber stations 101 and the Base Station 133. When a call is initiated, the control channel is used to communicate between the wireless subscriber device 101 involved in the call and the local serving Base Station 133. The control messages locate and identify the wireless subscriber device 101, determine the dialed number, and identify an available voice/data communication channel consisting of a pair of radio frequencies and orthogonal coding which is selected by the Base Station 133 for the communication connection. The radio unit in the wireless subscriber device 101 re-tunes the transmitter-receiver equipment contained therein to use these designated radio frequencies and orthogonal coding. Once the communication connection is established, the control messages are typically transmitted to adjust transmitter power and/or to change the transmission channel when required to handoff this wireless subscriber device 101 to an adjacent cell, when the subscriber moves from the present cell to one of the adjoining cells. The transmitter power of the wireless subscriber device 101 is regulated since the magnitude of the signal received at the Base Station 133 is a function of the subscriber station transmitter power and the distance from the Base Station 133. Therefore, by scaling the transmitter power to correspond to the distance from the Base Station 133, the received signal magnitude can be maintained within a predetermined range of values to ensure accurate signal reception without interfering with other transmissions in the cell.

The voice communications between wireless subscriber device 101 and other subscriber stations, such as land line based subscriber station 109, is effected by routing the communications received from the wireless subscriber device 101 through the Mobile Switching Center 106D and trunks to the Public Switched Telephone Network (PSTN) 108 where the communications are routed to a Local Exchange Carrier 125 that serves land line based subscriber station 109 and terminal devices 121. There are numerous Mobile Switching Centers 106D that are connected to the Public Switched Telephone Network (PSTN) 108 to thereby enable subscribers at both land line based subscriber stations and wireless subscriber devices to communicate between selected stations thereof. This architecture represents a typical present architecture of wireless and land line communication networks. An alternative network architecture, not illustrated here but presently in use in some networks, entails the use of a Public Land Mobile Network (PLMN) operated by a mobile service provider to interconnect their Mobile Switching Centers in a manner that is analogous to the above-noted network operation.

Call Origination Process

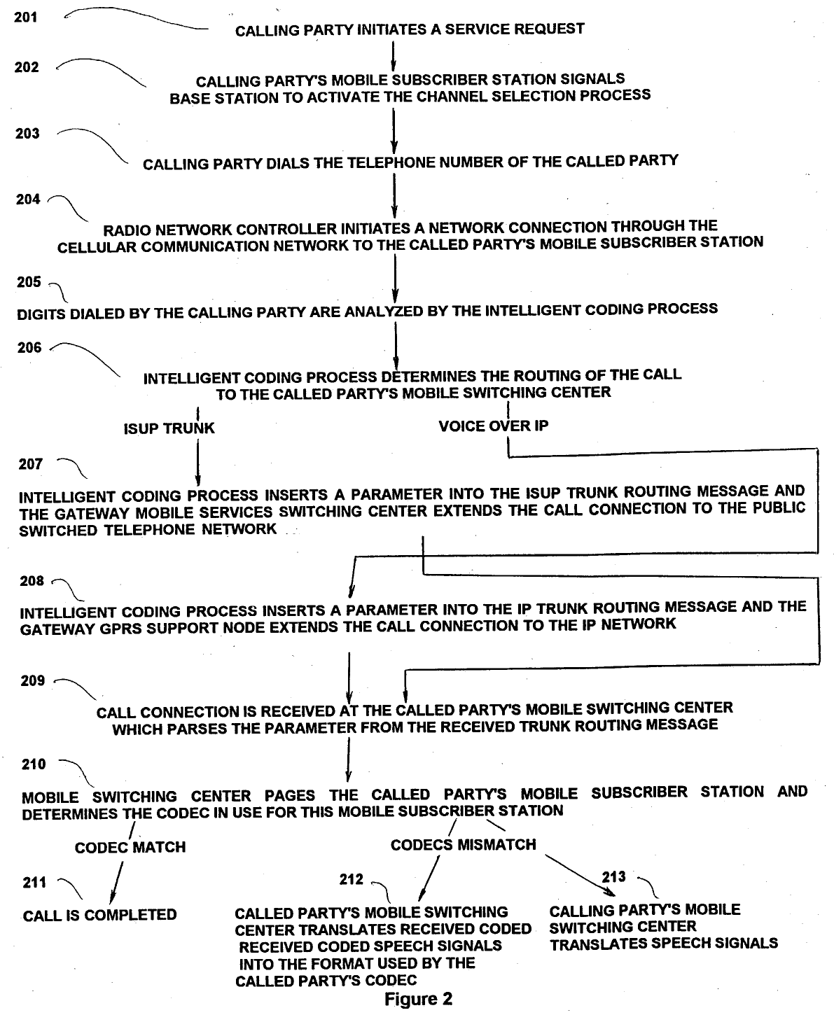

FIG. 2 illustrates in flow diagram form the operation of the intelligent coding process 100 in interconnecting two mobile subscriber stations. At step 201, a calling party at the originating mobile subscriber station 101, initiates a service request in standard fashion. The mobile subscriber station 101 at step 202 signals the base station 133 in the serving Radio Network Subsystem 131 to activate the channel selection process. At step 203, the calling party dials the telephone number of the called party, such as mobile subscriber station 101′, and the Radio Network Controller 132 initiates a network connection at step 204 through the cellular communication network 106 to the called party's mobile subscriber station 101′ by signaling the Mobile Switching Center 106D.

The digits dialed by the calling party are analyzed at step 205 by the intelligent coding process 100, which is a process that executes in the Mobile Switching Centers 102D, 106D. The intelligent coding process 100 of the Mobile Switching Center 106D determines at step 206 whether the called party is another mobile subscriber station 101′, and if so the routing of the call to the called party's Mobile Switching Center 102D. If the intra-called party's Mobile Switching Center trunk selected for call routing is an ISUP trunk through the Public Switched Telephone Network 108 to the called party's Mobile Switching Center 102D, then the intelligent coding process 100 at step 207 inserts a parameter into the ISUP trunk routing message and the Gateway Mobile Services Switching Center (GMSC) 106A extends the call connection to the Public Switched Telephone Network 108. If the routing of the call is over a Voice over IP connection, then the intelligent coding process 100 at step 208 inserts a parameter into the IP trunk routing message and the Gateway GPRS Support Node (GGSN) 106B extends the call connection to the IP Network 107. In a 3GPP-based Network, the message can be the IAM-ISOP message or the SIP180 message in a GPP2-based Network. The message used and the particular fields implemented in the message are matters of network administration and are not intended to limit the scope of the present inventive concept.

At step 209, the call connection is received at the called party's Mobile Switching Center 102D, and the intelligent coding process 100′ of the called party's Mobile Switching Center 102D parses the parameter from the received trunk routing message. The Mobile Switching Center 102D at step 210 pages the called party's mobile subscriber station 101′ and determines the codec in use for this mobile subscriber station 101′. If the codec for the called party's mobile subscriber station 101′ matches the codec used by the calling party's mobile subscriber station 101, then the intelligent coding process 100′ activates the Mobile Switching Center 102D to complete the call at step 211 and the use of the vocoder in the call connection is eliminated. If the calling party and called party codecs do not match, then the Mobile Switching Center 102D at step 212 translates the received coded speech signals into the format used by the called party's codec. If the called party's Mobile Switching Center 102D can't translate the received coded speech signals into the format used by the called party's codec, then the intelligent coding process 100′ of the called party's Mobile Switching Center 102D signals the intelligent coding process 100 of the calling party's Mobile Switching Center 106D to either implement the translation of the received coded speech signals into the format used by the called party's codec or to translate into the G.711 format and transmit the translated signals to the called party.

### SUMMARY

The intelligent coding process obtains data indicative of the end user device characteristics during the call setup process and can determine the optimal speech coding process necessary to efficiently use the available bandwidth and match the speech coding requirements of the end user devices.

What is claimed:

1. A method, executing in a wireless communications network, for establishing a call connection between a calling party's mobile subscriber station served by a first Mobile Switching Center and a called party's mobile subscriber station served by a second Mobile Switching Center, comprising:
determining, in response to a call initiation by a calling party's mobile subscriber station, whether the called party is served by a mobile subscriber station;
selecting a call routing via trunks that interconnect said first Mobile Switching Center and said second Mobile Switching Center; and
inserting a parameter into a call setup message transmitted by said first Mobile Switching Center to said second Mobile Switching Center to indicate that the call connection is a mobile to mobile call connection and the identity of a codec used for said calling party's mobile subscriber station.

2. The method for establishing a call connection of claim 1 further comprising:
determining in said second Mobile Switching Center an identity of a codec used for said called party's mobile subscriber station.

3. The method for establishing a call connection of claim 2 wherein said step of determining comprises:
paging said called party's mobile subscriber station to determine codec characteristics of said called party's mobile subscriber station.

4. The method for establishing a call connection of claim 2 further comprising:
determining an identity of a codec used for said calling party's mobile subscriber station from said parameter in said call setup message;
comparing an identity of a codec used for said called party's mobile subscriber station with an identity of a codec used by said calling party's mobile subscriber station; and
transmitting signals received over said call connection to said called party's mobile subscriber station if said codec identities match.

5. The method for establishing a call connection of claim 4 further comprising:
translating, in response to said codec identities being a mismatch, speech signals received on said call connection at said second Mobile Switching Center to match an identity a codec used for said called party's mobile subscriber station; and
transmitting said translated speech signals to said called party's mobile subscriber station.

6. The method for establishing a call connection of claim 4 further comprising:
transmitting a control message from said second Mobile Switching Center to said first Mobile Switching Center indicating the presence of said mismatch;
translating speech signals received from said calling party's mobile subscriber station at said first Mobile Switching Center to match an identity a codec used for said called party's mobile subscriber station; and
transmitting said translated speech signals to said called party's mobile subscriber station.

7. The method for establishing a call connection of claim 1 wherein said step of selecting comprises:
activating the Gateway Mobile Services Switching Center of said first Mobile Switching Center to select an ISUP trunk through the Public Switched Telephone Network to connect to said second Mobile Switching Center.

8. The method for establishing a call connection of claim 1 wherein said step of selecting comprises:
activating the Gateway GPRS Support Node of said first Mobile Switching Center to select a Voice over IP trunk through the IP Network to connect to said second Mobile Switching Center.

9. A method, executing in a wireless communications network, for establishing a call connection between a calling party's mobile subscriber station served by a first Mobile Switching Center and a called party's mobile subscriber station served by a second Mobile Switching Center, comprising:
determining, in response to a call initiation by a calling party's mobile subscriber station, whether the called party is served by a mobile subscriber station;
selecting a call routing via trunks that interconnect said first Mobile Switching Center and said second Mobile Switching Center;
inserting a parameter into a call setup message transmitted by said first Mobile Switching Center to said second Mobile Switching Center to indicate that the call connection is a mobile to mobile call connection and the identity of a codec used for said calling party's mobile subscriber station;
paging said called party's mobile subscriber station to determine codec characteristics of said called party's mobile subscriber station;
comparing an identity a codec used for said called party's mobile subscriber station with an identity of a codec used by said calling party's mobile subscriber station; and
transmitting signals received over said call connection to said called party's mobile subscriber station if said codec identities match.

10. The method for establishing a call connection of claim 9 further comprising:
determining an identity a codec used for said calling party's mobile subscriber station from said parameter in said call setup message.

11. The method for establishing a call connection of claim 10 further comprising:
translating, in response to said codec identities being a mismatch, speech signals received on said call connection to match an identity a codec used for said called party's mobile subscriber station; and
transmitting said translated speech signals to said called party's mobile subscriber station.

12. The method for establishing a call connection of claim 10 further comprising:
transmitting a control message from said second Mobile Switching Center to said first Mobile Switching Center indicating the presence of said mismatch;
translating speech signals received from said calling party's mobile subscriber station at said first Mobile Switching Center to match an identity a codec used for said called party's mobile subscriber station; and
transmitting said translated speech signals to said called party's mobile subscriber station.
